(19) United States
(12) Patent Application Publication
(10) Pub. No.: US 2014/0087678 A1
(43) Pub. Date: Mar. 27, 2014

(54) APPARATUS AND SYSTEM FOR RECEIVING WIRELESS SIGNAL WITH ANTI-JAMMING

(71) Applicant: ELECTRONICS AND TELECOMMUNICATIONS RESEARCH INSTITUTE, Daejeon (KR)

(72) Inventors: So Hyeun YUN, Daejeon (KR); Man Seok UHM, Daejeon (KR); Jang Sup CHOI, Daejeon (KR); Chang Soo KWAK, Daejeon (KR); Hong Yeol LEE, Cheongju-si Chungcheongbuk-do (KR); Jeom Hun LEE, Daejeon (KR); In Bok YOM, Daejeon (KR)

(73) Assignee: Electronics And Telecommunications Research Institute, Daejeon (KR)

(21) Appl. No.: 13/715,159

(22) Filed: Dec. 14, 2012

(30) Foreign Application Priority Data
Sep. 27, 2012 (KR) 10-2012-0108189

(51) Int. Cl. H04B 1/10

(52) U.S. Cl. CPC H04B 1/10
USPC 455/296

(57) ABSTRACT

The apparatus for receiving a wireless signal with anti-jamming includes: a wireless signal receiving unit receiving a wireless signal and including at least one antenna; and a jamming signal blocking unit disposed in front of the wireless signal receiving unit to block a jamming signal input from at least one direction and having a size or an interval from the wireless signal receiving unit determined according to at least one of an antenna pattern of the wireless signal receiving unit, a direction in which the jamming signal is input, and a level of the jamming signal. According to an exemplary embodiment of the present invention, it is possible to smoothly receive a targeted signal while blocking the jamming signal under the environment in which a general signal and the jamming signal coexist.

### CROSS-REFERENCE TO RELATED APPLICATIONS

This application claims priority to and the benefit of Korean Patent Application No. 10-2012-0108189 filed in the Korean Intellectual Property Office on Sep. 27, 2012, the entire contents of which are incorporated herein by reference.

### TECHNICAL FIELD

The present invention relates to an apparatus and a system for receiving a wireless signal including an antenna, and more particularly, to an apparatus and a system for receiving a wireless signal with anti-jamming.

### BACKGROUND ART

A jamming signal transmits crosstalk signals to satellite receiving apparatuses such as a global positioning system (GPS) and a global navigation satellite (GNSS) and may break the satellite receiving apparatuses. Therefore, technologies for protecting the satellite receiving apparatuses from the jamming signal have been continuously developed.

The technologies suggested in the related art include a jamming signal processing apparatus in an antenna or include a program for processing a jamming signal in the signal processing apparatus. However, these technologies make a structure of hardware or software complicated, such that much time and cost are required.

As the technologies suggested in the related art, there is a technology of strategically arranging passive open circuited antennas around a satellite navigation receiving antenna. The passive open circuited antenna has a sealing structure including an inner conductor and is to receive the jamming signal. The technology has a simpler structure than other technologies. However, a large number of passive open circuited antennas are required to apply electrical signals to a ground, and therefore much cost is required.

### SUMMARY OF THE INVENTION

The present invention has been made in an effort to provide an apparatus and a system for receiving a wireless signal with anti-jamming, in which a conductive breaker having a plate shape is disposed in front of an antenna.

However, objects of the present invention are not limited the above-mentioned matters and other objects can be clearly understood to those skilled in the art from the following descriptions.

An exemplary embodiment of the present invention provides an apparatus for receiving a wireless signal with anti-jamming, including: a wireless signal receiving unit receiving a wireless signal and including at least one antenna; and a jamming signal blocking unit disposed in front of the wireless signal receiving unit to block a jamming signal input from at least one direction and having a size or an interval from the wireless signal receiving unit determined according to at least one of an antenna pattern of the wireless signal receiving unit, a direction in which the jamming signal is input, and a level of the jamming signal.

The jamming signal blocking unit may be formed as a coupling body in which flat panels having conductivity and directing different directions are coupled.

A length and a width of the flat panel may be determined based on the size of the jamming signal blocking unit and at least one difference of a height difference between an upper surface of the wireless signal receiving unit and an upper surface of the jamming signal blocking unit and a distance difference between one side of the wireless signal receiving unit and one side of the jamming signal blocking unit that face each other is determined based on the interval of the jamming signal blocking unit.

The jamming signal blocking unit may be formed as a [symbol] -shaped coupling body in which the flat panels are coupled in a [symbol] shape or a [symbol] -shaped coupling body in which the flat panels are coupled in a [symbol] shape.

The jamming signal blocking unit may have conductivity and may be formed in a half cylinder or a half elliptic cylinder of which the top and bottom are opened.

When the jamming signal blocking unit blocks the jamming signal input from above at 50° to 90° from the upper surface of the wireless signal receiving unit, the size thereof may be formed to be 0.5λ to 0.9λ larger than that of the wireless signal receiving unit and the interval between the jamming signal blocking unit and the wireless signal receiving unit may be set to be 0.1λ to 0.3λ.

The jamming signal blocking unit may block the jamming signal by reflection or scattering and have a radio wave absorber attached to an inner surface thereof according to the scattered degree.

The jamming signal blocking unit may include the radio wave absorber attached to an upper portion of the inner surface thereof and a cross-sectional area ratio of the inner surface to which the radio wave absorber is attached and the inner surface to which the radio wave absorber is not attached may be 1:4.

The jamming signal blocking unit may block the jamming signal by cross polarization and at least one difference of a first height difference between the upper surface of the wireless signal receiving unit and the upper surface of the jamming signal blocking unit and a distance difference between one side of the wireless signal receiving unit and one side of the jamming signal blocking unit that face each other and a second height difference between a lower surface of the wireless signal receiving unit and a lower surface of the jamming signal blocking unit may be determined based on the interval.

When the jamming signal blocking unit blocks the jamming signal input from above at 50° to 90° from the upper surface of the wireless signal receiving unit, the first height difference and the distance difference may be set to be 0.1λ to 0.3λ and the second height difference may be set to be 0.01λ to 0.1λ.

The jamming signal blocking unit may be rotatably driven according to a direction in which the jamming signal is input.

The wireless signal receiving unit may receive the satellite signal as the wireless signal.

Another exemplary embodiment of the present invention provides a system for receiving a wireless signal with anti-jamming, including: a wireless signal receiving unit receiving a wireless signal and including at least one antenna; a jamming signal blocking unit disposed in front of the wireless signal receiving unit to block a jamming signal input from at least one direction and having a size or an interval from the wireless signal receiving unit determined according to at least one of an antenna pattern of the wireless signal receiving unit, a direction in which the jamming signal is input, and a level of the jamming signal; and a wireless signal processing unit processing the received wireless signal.

The wireless signal processing unit may include a jamming determining unit determining the received wireless signal as a jamming signal when a size of the received wireless signal is larger than that of the reference signal by comparing the size of the received wireless signal with a size of a reference signal; a first signal processing unit removing the received wireless signal if the received wireless signal is determined as the jamming signal; and a second signal processing unit processing the received wireless signal if the received wireless signal is not determined as the jamming signal.

The exemplary embodiments of the present invention can obtain the following effects by providing the apparatus and system for receiving a wireless signal with anti-jamming including the conductive breaker having a plate shape in front of an antenna. First, it is possible to smoothly receive the targeted signal while blocking the jamming signal under the environment in which the general signal and the jamming signal coexist. Second, it is possible to simplify the structure of hardware and software and save time and cost. Third, it is possible to save cost by disposing a single breaker in front of the antenna.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating an apparatus for receiving a wireless signal with anti-jamming according to an exemplary embodiment of the present invention.

FIG. 2 is a conceptual diagram of an anti-jamming antenna apparatus according to a first exemplary embodiment of the present invention.

FIG. 3 is a conceptual diagram of an antenna apparatus according to a first type as the anti-jamming antenna apparatus according to the first exemplary embodiment of the present invention.

FIG. 4 is a conceptual diagram of an antenna apparatus according to a second type of the anti-jamming antenna apparatus according to the first exemplary embodiment of the present invention.

FIG. 5 is a conceptual diagram of an antenna apparatus according to a third type of the anti-jamming antenna apparatus according to the first exemplary embodiment of the present invention.

FIG. 6 is a conceptual diagram of an anti-jamming antenna apparatus according to a second exemplary embodiment of the present invention.

FIGS. 7 and 8 are diagrams illustrating a coordinate axis of the anti-jamming antenna apparatus.

FIG. 9 is a comparison diagram of antenna pattern characteristics of the antenna apparatus according to the related art and the antenna apparatus according to the exemplary embodiment of the present invention.

FIG. 10 is a conceptual diagram of an anti-jamming antenna apparatus according to a third exemplary embodiment of the present invention.

FIG. 11 is a comparison diagram of antenna pattern characteristics of the antenna apparatus according to the related art and the antenna apparatus according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

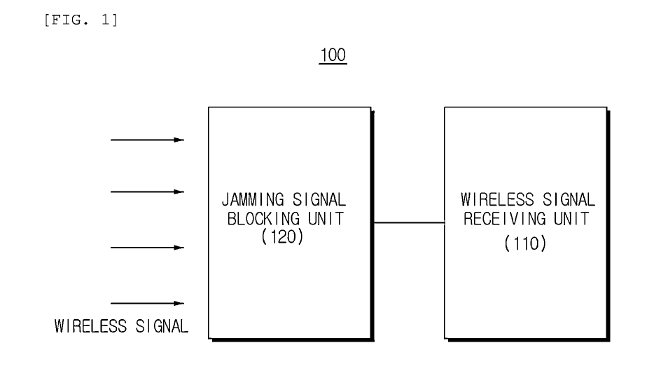

FIG. 1 is a block diagram schematically illustrating an apparatus for receiving a wireless signal with anti-jamming according to an exemplary embodiment of the present invention. Referring to FIG. 1, an apparatus 100 for receiving a wireless signal with anti-jamming includes a wireless signal receiving unit 110 and a jamming signal blocking unit 120.

The wireless signal receiving unit 110 receives a wireless signal and includes at least one antenna. The wireless signal receiving unit 110 may receive a satellite signal as a wireless signal. The wireless signal receiving unit 110 may be implemented as a satellite receiving antenna described as an exemplary embodiment of the present invention.

The jamming signal blocking unit 120 is disposed in front of the wireless signal receiving unit 110 to block the jamming signal input from at least one direction. A size of the jamming signal blocking unit 120 or an interval between the jamming signal blocking unit and the wireless signal receiving unit 110 is determined according to at least one of an antenna pattern of the wireless signal receiving unit 110, a direction in which the jamming signal is input, and a level of the jamming signal. The jamming signal blocking unit 120 may be implemented as an anti-jamming structure described as the exemplary embodiment of the present invention.

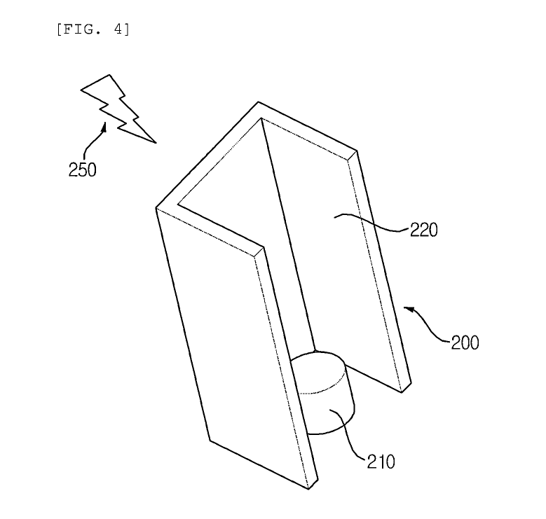

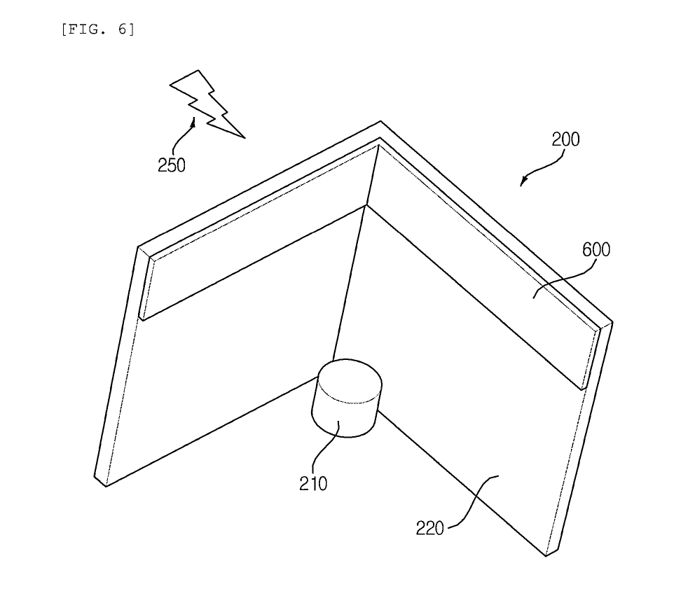

The jamming signal blocking unit 120 may be formed as a coupling body in which flat panels having conductivity and directing different directions are coupled. The anti-jamming structure illustrated in FIGS. 4 and 6 is an example in which the jamming signal blocking unit 120 is formed as the coupling body. However, in the exemplary embodiment of the present invention, the jamming signal blocking unit 120 may be formed as an integrated type rather than being formed as the coupling body.

When the jamming signal blocking unit 120 is formed as the coupling body in which the flat panels are coupled, the size thereof may be determined by a sum of a length and a width of each flat panel. When the jamming signal blocking unit 120 is formed as the coupling body in which the flat panels are coupled, the interval between the jamming signal blocking unit 120 and the wireless signal receiving unit 110 may be determined by at least one difference of a height difference between an upper surface of the wireless signal receiving unit 110 and an upper surface of the jamming signal blocking unit 120 and a distance difference between one side of the wireless signal receiving unit 110 and one side of the jamming signal blocking unit 120 that face each other.

For example, when the jamming signal blocking unit 120 blocks the jamming signal input from above at 50° to 90° from the upper surface of the wireless signal receiving unit 110, the size thereof is formed to be 0.5λ to 0.9λ larger than that of the wireless signal receiving unit 110 and the interval between the jamming signal blocking unit 120 and the wireless signal receiving unit 110 is set to be 0.1λ to 0.3λ.

When the jamming signal blocking unit 120 is formed as the coupling body in which the flat panels are coupled, the flat panels may be formed as a [symbol] -shaped coupling body in which the flat panels are coupled in a [symbol] shape and may also be formed as a [symbol] -shaped coupling body in which the flat panels are coupled in a [symbol] shape.

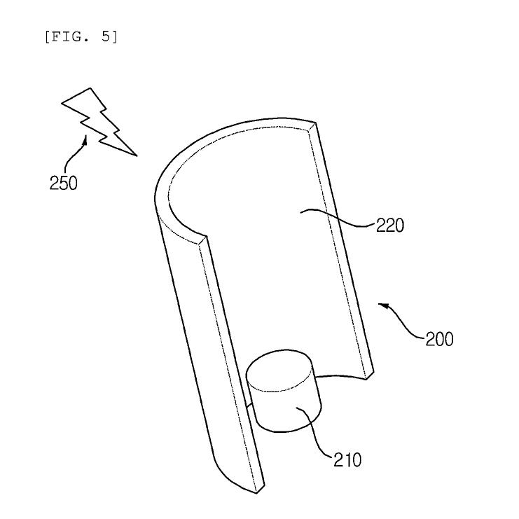

Meanwhile, the jamming signal blocking unit 120 has conductivity and may also be formed in a half cylinder or a half elliptic cylinder of which the top and the bottom are opened. The anti-jamming structure illustrated in FIG. 5 is an example in which the jamming signal blocking unit 120 is formed as a semi circular body.

In this case, the size of the jamming signal blocking unit 120 may be determined by a circumference and a width of a half cylinder or a half elliptic cylinder and the interval between the jamming signal blocking unit 120 and the wireless signal receiving unit 110 may be determined by the same manner as in the case in which the jamming signal blocking unit 120 is formed as a coupling body.

The jamming signal blocking unit 120 may block the jamming signal by reflection or scattering. In this case, the jamming signal blocking unit 120 may include a radio wave absorber attached to an inner surface thereof according to the scattered degree. For example, the jamming signal blocking unit 120 may include the radio wave absorber attached to an upper portion of the inner surface thereof. In this case, a cross-sectional area ratio of the inner surface to which the radio wave absorber is attached and the inner surface to which the radio wave absorber is not attached may be 1:3 to 5 (preferably, 1:4).

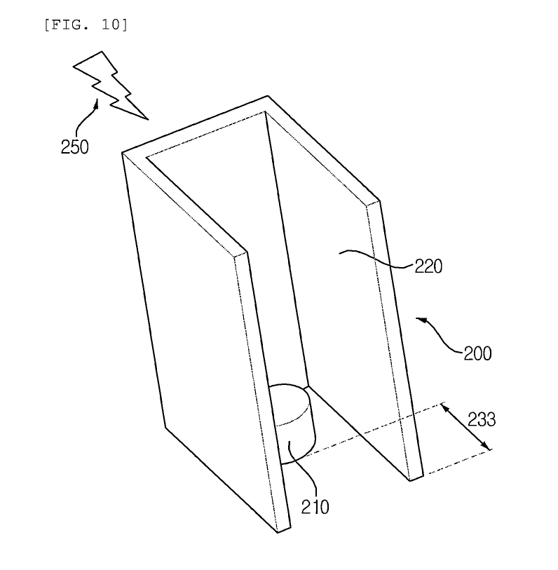

The jamming signal blocking unit 120 may block the jamming signal by cross polarization. In this case, the interval between the jamming signal blocking unit 120 and the wireless signal receiving unit 110 may be determined by at least one difference value of a first height difference between the upper surface of the wireless signal receiving unit 110 and the upper surface of the jamming signal blocking unit 120 and a distance difference between one side of the wireless signal receiving unit 110 and one side of the jamming signal blocking unit 120 that face each other and a second height difference between a lower surface of the wireless signal receiving unit 110 and a lower surface of the jamming signal blocking unit 120. The anti-jamming structure illustrated in FIG. 10 is an example in which the jamming signal blocking unit 120 blocks the jamming signal by the cross polarization.

For example, when the jamming signal blocking unit 120 blocks the jamming signal input from above at 50° to 90° from the upper surface of the wireless signal receiving unit 110, the first height difference and the distance difference are set to be 0.1λ to 0.3λ and the second height difference is set to be 0.01λ to 0.1λ. Meanwhile, the jamming signal blocking unit 120 may be rotatably driven according to a direction in which the jamming signal is input. In this case, the jamming signal blocking unit 120 may be rotatably driven vertically and horizontally but may be rotatably driven either horizontally or vertically.

As described above, the apparatus 100 for receiving a wireless signal with anti-jamming does not need additional hardware and software in the satellite receiving apparatus. The apparatus 100 for receiving a wireless signal with anti-jamming does not require an electrical signal upon mounting a simple structure therearound without deforming the satellite receiving apparatus. The apparatus 100 for receiving a wireless signal with anti-jamming may receive a satellite signal while effectively blocking the jamming signal.

The apparatus 100 for receiving a wireless signal with anti-jamming according to the exemplary embodiment of the present invention may be included in an antenna system including a signal processing apparatus. The system for receiving a wireless signal with anti-jamming to be described below has the same concept as the antenna system.

The system for receiving a wireless signal with anti-jamming includes the apparatus 100 for receiving a wireless signal with anti-jamming and a wireless signal processing unit.

The wireless signal processing unit serves to process the received wireless signal. The wireless signal processing unit may include a jamming determining unit, a first signal processing unit, and a second signal processing unit.

The jamming determining unit compares a size of the received wireless signal with a size of a reference signal to determine the wireless signal as the jamming signal when the size of the wireless signal is larger than the size of the reference signal.

The first signal processing unit removes the received wireless signal when the received wireless signal is determined as the jamming signal.

The second signal processing unit processes the received wireless signal when the received wireless signal is not determined as the jamming signal.

The apparatus 100 receiving a wireless signal with anti-jamming may further improve the anti-jamming effect than the existing antenna apparatus using the jamming signal blocking unit 120. However, since the jamming signal may be input even in the direction in which the jamming signal blocking unit 120 is not installed, the system for receiving a wireless signal with anti-jamming may include a wireless signal processing unit including the jamming determining unit and the first signal processing unit in consideration of the input jamming signal. The configuration may further improve the anti-jamming effect than the case in which only the jamming signal blocking unit 120 is provided.

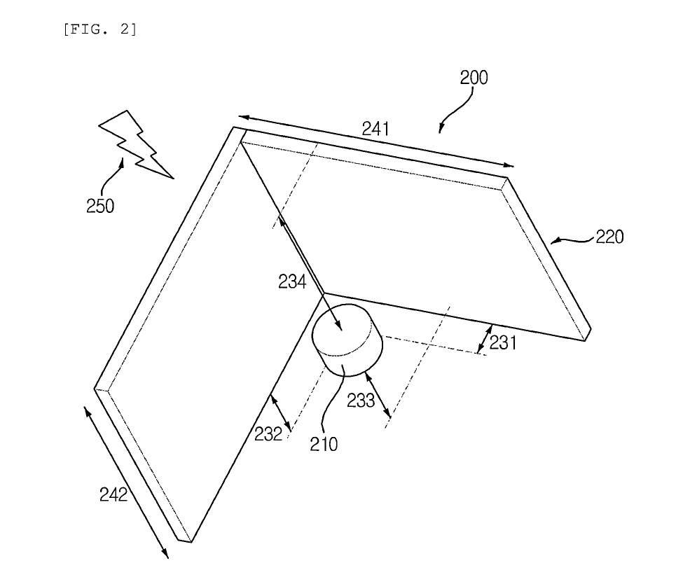

Next, an exemplary embodiment of the apparatus 100 for receiving a wireless signal with anti-jamming will be described. FIG. 2 is a conceptual diagram of an anti-jamming antenna apparatus according to a first exemplary embodiment of the present invention. An anti-jamming antenna apparatus 200 is an apparatus that transmits a crosstalk signal to the satellite receiving antenna or blocks the jamming signal capable of breaking the satellite receiving antenna. The following description refers to FIG. 2.

Generally, the satellite receiving antenna reduces antenna directivity so as to receive all the signals from a zenith angle to a low elevation angle and has quasi-omnidirectional characteristics. Therefore, a general satellite receiving antenna receives a satellite transmitting signal and the jamming signal. However, the jamming signal disturbs or breaks the satellite signal since the size of the jamming signal is generally larger than that of the satellite signal in many cases.

An anti-jamming structure 220 is used to block a jamming signal 250. The anti-jamming antenna apparatus 200 is configured by a satellite receiving antenna 210 and the anti-jamming structure 220 configured of a conductor plate.

In the anti-jamming antenna apparatus 200, the anti-jamming structure 200 serves to reflect or scatter electromagnetic waves. The anti-jamming structure 220 also serves to change the pattern of the satellite receiving antenna 210. In this case, the desired antenna pattern change may be obtained according to intervals 231, 232, 233, and 234 between the satellite receiving antenna 210 and the anti-jamming structure 220 and sizes 241 and 242 of the anti-jamming structure 220.

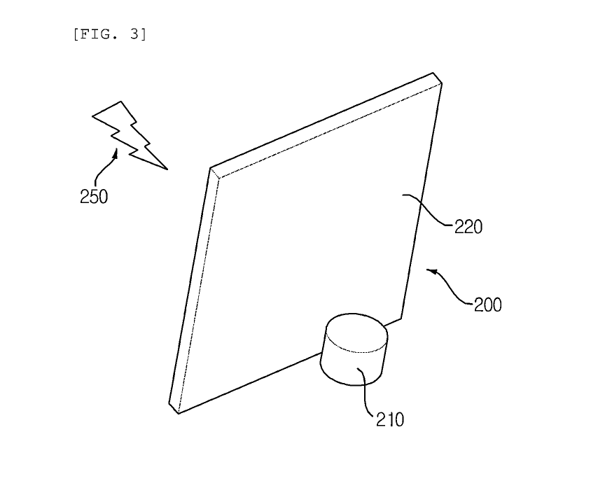

The shape and size of the anti-jamming structure 220 may be variously changed according the direction of the jamming signal or the targeted anti-jamming level. FIGS. 2 to 5 illustrate various shapes of the anti-jamming antennal apparatus 200. FIG. 3 illustrates an example of a - shaped single body configured of one flat plate, FIG. 2 illustrates an example of a [symbol] -shaped coupling body in which two flat plates are coupled, FIG. 4 illustrates an example of a [symbol] -shaped coupling body in which three flat plates are coupled, and FIG. 5 illustrates an example of a U-shaped single body formed of a single half-cylindrical plate. FIGS. 3 to 5 illustrate an example in which the height difference between the lower surface of the anti-jamming structure 220 and the lower surface of the satellite receiving antenna 210 is 0. FIGS. 2 to 5 illustrate an example in which the anti-jamming structure 220 is configured of a reflector.

For example, when any antenna having the quasi-isotropic characteristics is used as the satellite receiving antenna 210 and a [symbol] -shaped structure of FIG. 2 is used as the anti-jamming structure 200, the anti-jamming structure 220 is designed such that two flat panels extended 0.5λ more than the length of the satellite receiving antenna 210 are coupled and the interval between the satellite receiving antenna 210 and the anti-jamming structure 220 is 0.3λ or less, so as to obtain the blocking characteristics of 10 dB or more at an angle of 50° or more from a ceiling.

The anti-jamming structure 220 may also be configured to have a structure of reducing the radio wave scattering. In order to reduce the radio wave scattering for the satellite signal direction, an absorber 600 may be attached to a part or the entirety of the anti-jamming structure 220 as illustrated in FIG. 6. FIG. 6 is a conceptual diagram of an anti-jamming antenna apparatus according to a second exemplary embodiment of the present invention. When the absorber 600 is attached to the anti-jamming structure 220 exhibiting the reflector performance, both of the jamming signal blocking performance and the satellite signal receiving performance may be improved. When the performance of the anti-jamming structure 220 and the economic usage of the absorber 600 are considered, a configuration ratio of the reflector and the absorber may be most appropriately 1:4.

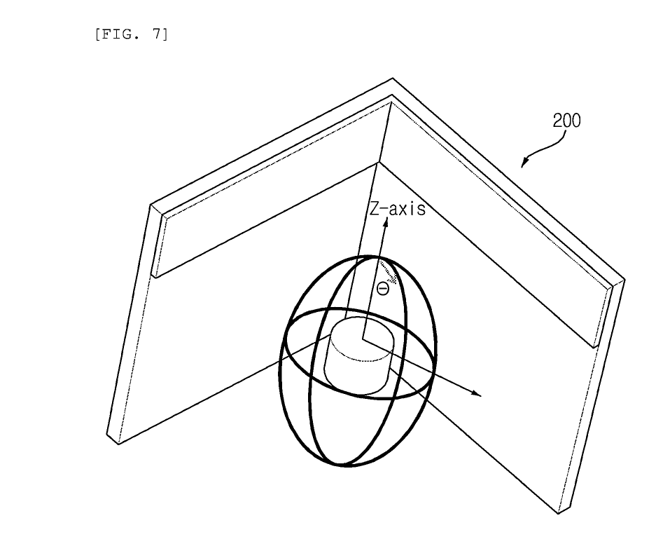

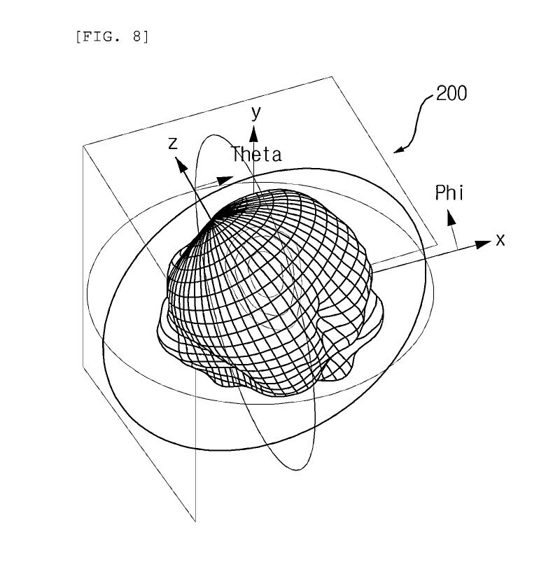

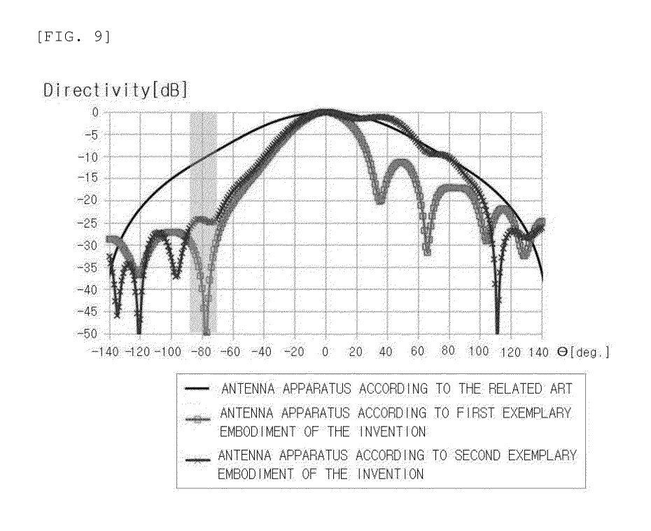

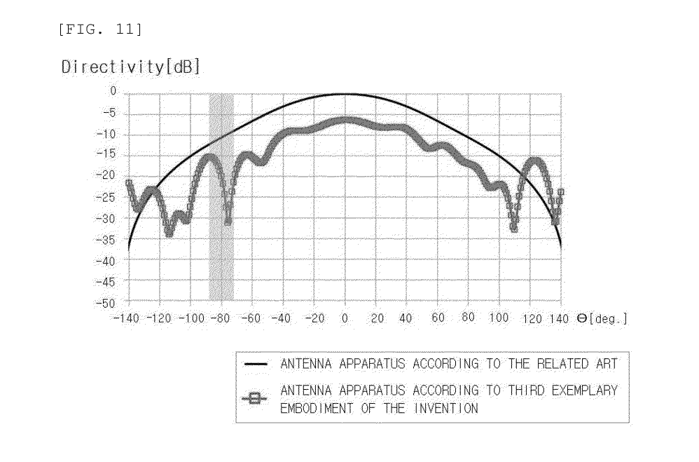

FIGS. 7 and 8 are diagrams illustrating a coordinate axis of the anti-jamming antenna apparatus. In FIGS. 7 and 8, a Z axis means a maximum gain direction of the satellite receiving antenna 210. In FIG. 7, θ means an angle toward an XY plane from the Z axis. In FIG. 7, θ is to describe an angle of θ that is represented on a horizontal axis of FIGS. 9 and 11.

FIG. 9 is a comparison diagram of antenna pattern characteristics of the antenna apparatus according to the related art and the antenna apparatus according to the exemplary embodiment of the present invention. The antenna apparatus according to the first exemplary embodiment of the present invention is as illustrated in FIG. 2 and includes the [symbol] -shaped structure. The antenna apparatus according to the second exemplary embodiment of the present invention is as illustrated in FIG. 6 and is attached with the absorber.

When the jamming signal is derived at an angle of θ=−80° from a ceiling, the antenna apparatus according to the first exemplary embodiment of the present invention does not receive the jamming signal since a pattern null is formed in the jamming signal direction. According to the antenna apparatus according to the second exemplary embodiment of the present invention, the jamming signal is deteriorated as much as 25 dB and the satellite signal direction θ>0° has approximately similar characteristics to the satellite receiving antenna 210 without the anti-jamming structure 220. This improves the anti-jamming characteristics as much as about 15 dB than the case in which the anti-jamming structure 220 is not used.

The anti-jamming structure 220 may be configured as a polarization conversion apparatus that may obtain the cross polarization. FIG. 10 is a conceptual diagram of an anti-jamming antenna apparatus according to a third exemplary embodiment of the present invention. The anti-jamming structure 220 in the anti-jamming antenna apparatus 200 of FIG. 10 is a [symbol] -shaped structure that is more extended than the satellite receiving antenna 210 to cross the polarization of the satellite receiving antenna 210, thereby blocking the jamming signal. For example, the extended length needs to be 0.1λ smaller than the height of the satellite receiving antenna 210.

The shape and size of the anti-jamming structure 220 for cross polarization generation of the receiving antenna 210 may be variously implemented. The antenna pattern according to the cross polarization anti-jamming structure 220 has the improved anti-jamming characteristics as illustrated in FIG. 11. However, since a gain in the satellite signal direction is also reduced, when the anti-jamming structure 220 having the cross polarization generation performance is used, it is preferable to install both of the satellite receiving antenna 210 and the anti-jamming structure 220.

A result of comparing characteristics of the antenna apparatus according to the exemplary embodiment of the present invention with the antenna apparatus according to the related art which were described with reference to FIGS. 2 to 11 is as follows.

(1) Antenna apparatus according to the related art

\textcircled{1} Anti-jamming signal blocking characteristics at θ=80°: −10.5 dB

\textcircled{2} Satellite signal receiving characteristics at θ=±15°: 7.2 dBi

(2) Antenna apparatus according to first exemplary embodiment of the present invention (antenna apparatus of FIG. 3)

\textcircled{1} Anti-jamming signal blocking characteristics at θ=80°: −17.1 dB

\textcircled{2} Satellite signal receiving characteristics at θ=±15°: 6.1 dBi

(3) Antenna apparatus according to first exemplary embodiment of the present invention (when the intervals between the antenna apparatus and 234 of FIG. 2 are 0 (antenna apparatus of FIG. 2, when 234 interval is 0)

\textcircled{1} Anti-jamming signal blocking characteristics at θ=80°: −30.9 dB

\textcircled{2} Satellite signal receiving characteristics at θ=±15°: 9.0 dBi

(4) Antenna apparatus according to first exemplary embodiment of the present invention (Antenna apparatus of FIG. 2)

\textcircled{1} Anti-jamming signal blocking characteristics at θ=80°: −40.0 dB

\textcircled{2} Satellite signal receiving characteristics at θ=±15°: 9.1 dBi

(5) Antenna apparatus according to first exemplary embodiment of the present invention (Antenna apparatus of FIG. 5)

\textcircled{1} Anti-jamming signal blocking characteristics at θ=80°: −15.3 dB

\textcircled{2} Satellite signal receiving characteristics at θ=±15°: 6.2 dBi

(6) Antenna apparatus according to second exemplary embodiment of the present invention (Antenna apparatus of FIG. 6, absorber 100%)

\textcircled{1} Anti-jamming signal blocking characteristics at θ=80°: −20.8 dB

\textcircled{2} Satellite signal receiving characteristics at θ=±15°: 10.7 dBi

(7) Antenna apparatus according to second exemplary embodiment of the present invention (Antenna apparatus of FIG. 6, absorber 20%)

\textcircled{1} Anti-jamming signal blocking characteristics at θ=80°: −25.0 dB

\textcircled{2} Satellite signal receiving characteristics at θ=±15°: 9.6 dBi

(8) Antenna apparatus according to third exemplary embodiment of the present invention (Antenna apparatus of FIG. 10)

\textcircled{1} Anti-jamming signal blocking characteristics at θ=80°: −12.5 dB

\textcircled{2} Satellite signal receiving characteristics at θ=±15°: 5.2 dBi

As described above, in the anti-jamming antenna apparatus according to the exemplary embodiment of the present invention, the conductive plate having a predetermined shape is used as the anti-jamming structure and the structure is installed around the satellite receiving antenna, thereby obtaining the foregoing effect.

The shape and installation position of the anti-jamming structure may be changed by the targeted antenna pattern. The anti-jamming antenna apparatus according to the exemplary embodiment of the present invention serves to deteriorate the antenna gain in the jamming direction while maintaining the antenna gain in the satellite signal direction to protect the satellite signal and the satellite receiver. The exemplary embodiment of the present invention may perform the function without additionally inserting the complicated hardware or software into the satellite receiving antenna and without changing the satellite receiving antenna. It is possible to receive the satellite signal and block the jamming signal, by installing the satellite receiving antenna and the anti-jamming structure for cross polarization together.

The anti-jamming antenna apparatus according to the exemplary embodiment of the present invention does not require several anti-jamming structures without applying a separate electrical signal to the anti-jamming structure.

Since the anti-jamming structure is not used as the antenna, a complicated process of comparing the jamming signal receiving size with the satellite signal receiving size may be omitted.

Meanwhile, even though it is described that all components configuring the embodiments of the present invention described above are integrally coupled or operated by being coupled, the present invention is not necessarily limited to the foregoing exemplary embodiments. That is, all the components may be operated by being selectively coupled in at least one within the scope of the present invention. Unless indicated otherwise, it is to be understood that all the terms used in the specification including technical and scientific terms have the same meaning as those that are understood by those who skilled in the art. It must be understood that generally used terms such as the terms defined by the dictionary are identical with the meanings within the context of the related art, and they should not be ideally or excessively formally interpreted unless the context clearly dictates.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for receiving a wireless signal with anti-jamming, comprising:
a wireless signal receiving unit receiving a wireless signal and including at least one antenna; and
a jamming signal blocking unit disposed in front of the wireless signal receiving unit to block a jamming signal input from at least one direction and having a size or an interval from the wireless signal receiving unit determined according to at least one of an antenna pattern of the wireless signal receiving unit, a direction in which the jamming signal is input, and a level of the jamming signal.

2. The apparatus of claim 1, wherein the jamming signal blocking unit is formed as a coupling body in which flat panels having conductivity and directing different directions are coupled.

3. The apparatus of claim 2, wherein a length and a width of the flat panel are determined based on the size of the jamming signal blocking unit and at least one difference of a height difference between an upper surface of the wireless signal receiving unit and an upper surface of the jamming signal blocking unit and a distance difference between one side of the wireless signal receiving unit 110 and one side of the jamming signal blocking unit 120 that face each other is determined based on the interval of the jamming signal blocking unit.

4. The apparatus of claim 2, wherein the jamming signal blocking unit is formed as a [symbol] -shaped coupling body in which the flat panels are coupled in a [symbol] shape or a [symbol] -shaped coupling body in which the flat panels are coupled in a [symbol] shape.

5. The apparatus of claim 1, wherein the jamming signal blocking unit has conductivity and is formed in a half cylinder or a half elliptic cylinder of which the top and bottom are opened.

6. The apparatus of claim 1, wherein when the jamming signal blocking unit blocks the jamming signal input from above at 50° to 90° from the upper surface of the wireless signal receiving unit, the size thereof is formed to be 0.5λ to 0.9λ larger than that of the wireless signal receiving unit and the interval between the jamming signal blocking unit and the wireless signal receiving unit is set to be 0.1λ to 0.3λ.

7. The apparatus of claim 1, wherein the jamming signal blocking unit blocks the jamming signal by reflection or scattering and has a radio wave absorber attached to an inner surface thereof according to the scattered degree.

8. The apparatus of claim 7, wherein the jamming signal blocking unit includes the radio wave absorber attached to an upper portion of the inner surface thereof and a cross-sectional area ratio of the inner surface to which the radio wave absorber is attached and the inner surface to which the radio wave absorber is not attached is 1:4.

9. The apparatus of claim 1, wherein the jamming signal blocking unit blocks the jamming signal by cross polarization and at least one difference of a first height difference between the upper surface of the wireless signal receiving unit and the upper surface of the jamming signal blocking unit and a distance difference between one side of the wireless signal receiving unit and one side of the jamming signal blocking unit that face each other and a second height difference between a lower surface of the wireless signal receiving unit and a lower surface of the jamming signal blocking unit are determined based on the interval.

10. The apparatus of claim 9, wherein when the jamming signal blocking unit blocks the jamming signal input from above at 50° to 90° from the upper surface of the wireless signal receiving unit, the first height difference and the distance difference are set to be 0.1λ to 0.3λ and the second height difference is set to be 0.01λ to 0.1λ.

11. The apparatus of claim 1, wherein the jamming signal blocking unit is rotatably driven according to a direction in which the jamming signal is input.

12. A system for receiving a wireless signal with anti-jamming, comprising:
a wireless signal receiving unit receiving a wireless signal and including at least one antenna;
a jamming signal blocking unit disposed in front of the wireless signal receiving unit to block a jamming signal input from at least one direction and having a size or an interval from the wireless signal receiving unit determined according to at least one of an antenna pattern of the wireless signal receiving unit, a direction in which the jamming signal is input, and a level of the jamming signal; and
a wireless signal processing unit processing the received wireless signal.
